(19) United States
(12) Patent Application Publication
(10) Pub. No.: US 2026/0046837 A1
(43) Pub. Date: Feb. 12, 2026

(54) COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: Akihisa Kinoshita, Tokyo (JP)

(21) Appl. No.: 19/308,749

(22) Filed: Aug. 25, 2025

Related U.S. Application Data
(63) Continuation of application No. PCT/JP2024/004257, filed on Feb. 8, 2024.

(30) Foreign Application Priority Data
Mar. 1, 2023 (JP) 2023-031318

(51) Int. Cl. H04W 68/00; H04W 76/10

(52) U.S. Cl. CPC H04W 68/00; H04W 76/10

(57) ABSTRACT

A communication apparatus receives a notification signal from an Integrated Access and Backhaul (IAB) node, performs determination of whether attribute information indicating that an IAB node as a transmission source of the notification signal is a moving IAB node configured to be movable is included in the notification signal, and decides, based on the determination, whether to perform connection to the IAB node as the transmission source of the notification signal.

### CROSS-REFERENCE TO RELATED APPLICATIONS

This application is a Continuation of International Patent Application No. PCT/JP2024/004257, filed Feb. 8, 2024, which claims the benefit of Japanese Patent Application No. 2023-031318, filed Mar. 1, 2023, both of which are hereby incorporated by reference herein in their entirety.

### BACKGROUND

### Field of the Technology

The present disclosure relates to a technique of selecting a connection destination in wireless communication.

### Description of the Related Art

In the 3rd Generation Partnership Project (3GPP®), the Integrated Access and Backhaul (IAB) technique has been standardized as a backhaul line configuration technique. In the IAB technique, a relay apparatus called an IAB node is wirelessly connected to an IAB donor serving as a base station, and uses, as a backhaul link, a radio link with the IAB donor (see PTL 1). In consideration of the 3GPP® release 18 standard, a use case is currently examined in which an IAB node is installed in a vehicle (a bus, a taxi, a train, or the like) and thus moves.

### CITATION LIST

### Patent Literature

[PTL 1] Japanese Patent Laid-Open No. 2019-534625

It is assumed that when user equipment (UE) exists near a moving IAB node, the UE is connected to the IAB node. On the other hand, in a case where the UE exists outside a vehicle in which the IAB node is installed, the UE cannot maintain the connection to the IAB node due to the movement of the vehicle. Therefore, when the UE is connected to the moving IAB node, it needs to execute handover. That is, since the UE selects an inappropriate connection destination, unnecessary handover may occur, thereby degrading the efficiency of a system as a whole. Similarly, when a communication apparatus that can function as an IAB node is connected to another IAB node, unnecessary handover may occur.

### SUMMARY

The present disclosure provides a technique of allowing a communication apparatus to select an appropriate connection destination.

A communication apparatus according to one aspect of the present disclosure comprises a reception unit configured to receive a notification signal from an Integrated Access and Backhaul (IAB) node, a determination unit configured to determine whether attribute information indicating that an IAB node as a transmission source of the notification signal is a moving IAB node configured to be movable is included in the notification signal, and a decision unit configured to decide, based on the determination, whether to perform connection to the IAB node as the transmission source of the notification signal.

A communication apparatus according to another aspect of the present disclosure is a communication apparatus functioning as an Integrated Access and Backhaul (IAB) node, comprising: a generation unit configured to generate, in a case where the communication apparatus is a moving IAB node configured to be movable, a first notification signal for User Equipment (UE), which includes attribute information indicating that the communication apparatus is the moving IAB node, and a second notification signal for an IAB node, which is different from the first notification signal and includes attribute information indicating that the communication apparatus is the moving IAB node; and a transmission unit configured to transmit the first notification signal and the second notification signal at different timings.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the configuration of a wireless communication system;

FIG. 2 is a block diagram showing an example of the hardware configuration of a communication apparatus;

FIG. 3 is a block diagram showing an example of the functional configuration of the communication apparatus;

FIG. 4 is a flowchart illustrating an example of the procedure of processing executed by an IAB node;

FIG. 5 is a flowchart illustrating an example of the procedure of processing executed by UE;

FIG. 6 is a sequence chart showing an example of the procedure of connection processing executed in the wireless communication system;

FIG. 7A is a view showing examples of a screen displayed on the UE;

FIG. 7B is a view showing examples of a screen displayed on the UE; and

FIG. 8 is a flowchart illustrating another example of the procedure of the processing executed by the UE.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### (System Configuration)

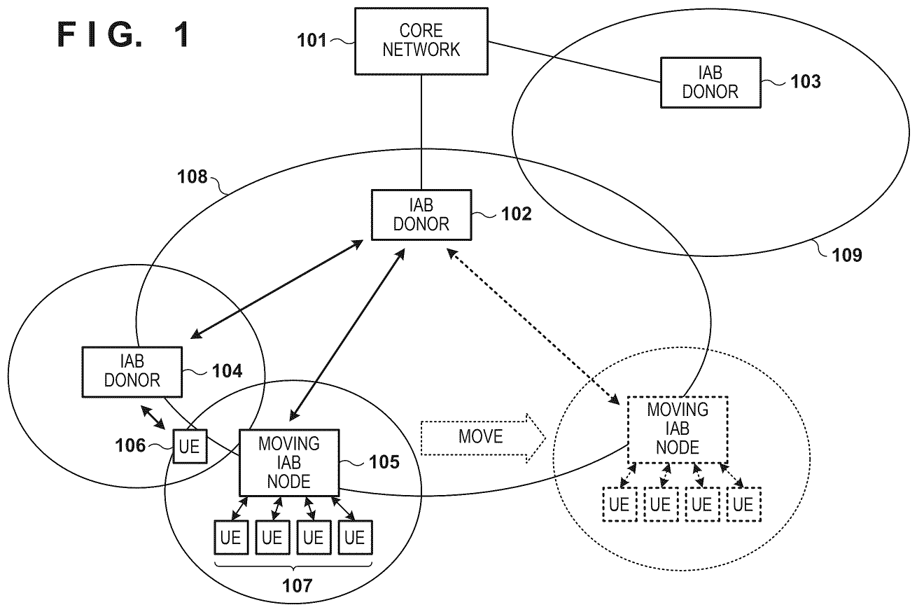

FIG. 1 shows an example of the configuration of a wireless communication system according to an embodiment. The wireless communication system is a relay communication system formed by using the Integrated Access and Backhaul (IAB) technique defined in the Third Generation Partnership Project (3GPP®). The wireless communication system is configured to include an IAB donor 102 and an IAB donor 103, each of which serves as a base station, and an IAB node 104 and an IAB node 105, each of which functions as a relay apparatus that relays communication between the base station and user equipment (each of UE 106 and UE 107). Note that UE is an acronym for User Equipment. FIG. 1 shows two IAB donors and two IAB nodes for the sake of descriptive simplicity. However, for example, the number of IAB donors may be one or three or more. The number of IAB nodes is not limited to two. The IAB donor 102 and the IAB donor 103 are connected to a core network 101. The core network 101 has functions such as connection management and movement management of user equipment and session management of the user equipment, and a user data communication processing function. The IAB donor 102 and the IAB donor 103 serve as base stations to form a cell 108 and a cell 109, respectively. Each of the IAB donor 102 and the IAB donor 103 can perform communication by establishing connection to user equipment existing within the range of the cell formed by the self-apparatus. Note that the user equipment also includes the mobile termination (MT) of the IAB node. That is, by using the function as the terminal, the IAB node can be connected to the IAB donor that forms the cell including a position where the self-apparatus exists. For example, the IAB node 104 and the IAB node 105 are located within the cell 108 formed by the IAB donor 102, and can be connected to the IAB donor 102. After establishing wireless connection to the IAB donor 102, each of the IAB node 104 and the IAB node 105 can set a BAP address, a routing ID, and the like with the IAB donor 102, thereby performing relay communication by the IAB technique. Note that BAP is an acronym for Backhaul Adaptation Protocol. Note also that settings between the IAB donor and the IAB node after wireless connection are made by a conventional method, and a description thereof will be omitted.

This embodiment assumes that the IAB node 105 is, for example, a moving IAB node that is installed in a bus, a train, or the like and configured to be movable. The UE 107 is, for example, UE held by a user who uses the bus, the train, or the like in which the IAB node 105 is installed. Note that the UE 107 may be, for example, UE connected to a sensor or the like in the moving body in which the IAB node 105 is installed. That is, the UE 107 is UE that moves together with the IAB node 105. On the other hand, the UE 106 is UE or the like held by a user who does not use the bus, the train, or the like in which the IAB node 105 is installed. That is, the UE 106 is UE that does not move together with the IAB node 105.

In this example, each of the UE 106 and the UE 107 measures a synchronization signal and a notification signal (Synchronization Signal and PBCH block (SSB)) from the IAB node or the IAB donor, thereby deciding a connection destination. For example, the UE 107 receives the SSB from the IAB node 105 with largest power, and selects the IAB node 105 as a connection destination. Assume that the UE 106 also receives the SSB from the IAB node 105 with largest power. In this case, the UE 106 selects the IAB node 105 as a connection destination. However, for example, the IAB node 105 may move in a direction away from the UE 106. In this case, even if the UE 106 is connected to the IAB node 105, radio quality with the IAB node 105 degrades quickly, and it is necessary to perform handover.

In consideration of the above problem, this embodiment provides a technique for preventing the UE 106 from being connected to the IAB node 105 that highly probably moves away from the self-apparatus. That is, each of the IAB node 104 and the IAB node 105 transmits a notification signal by including, in the notification signal, attribute information for allowing the UE to specify whether the self-apparatus is a moving IAB node. The notification signal is, for example, a broadcast signal that can be received by UE unconnected to each IAB node, such as a system information block (SIB). As described above, the attribute information is information including data indicating whether the IAB node as the transmission source of the notification signal is a moving IAB node. Thus, for example, the UE 106 can be connected not to the IAB node 105 as the moving IAB node but to the non-moving IAB node 104. Note that a communication apparatus that should function as an IAB node can use the attribute information when being connected to another IAB node. That is, the communication apparatus functioning as an AIB node determines, based on an attribute received from another IAB node, whether the other IAB node is a moving IAB node. Then, the IAB node can be configured not to be connected in a case where the other IAB node is a moving IAB node, and to be connected in a case where the other IA node is a non-moving IAB node.

Examples of the configuration of the apparatus that performs the above processing and the procedure of the processing will be described below.

### (Apparatus Configuration)

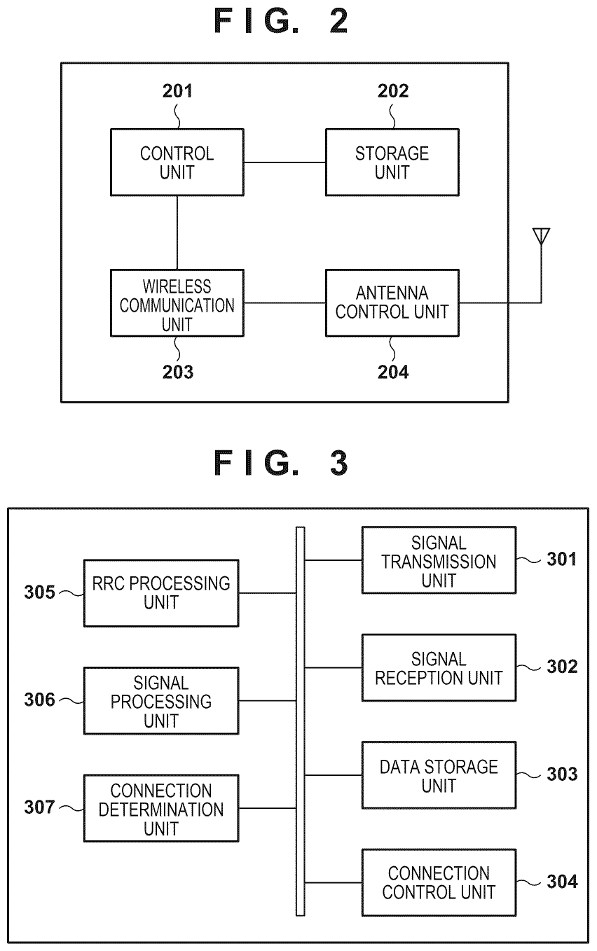

FIG. 2 shows an example of the hardware configuration of the communication apparatus corresponding to each of the IAB node and the UE according to this embodiment. For example, the communication apparatus is configured to include, as the hardware configuration, a control unit 201, a storage unit 202, a wireless communication unit 203, and an antenna control unit 204. The control unit 201 controls the overall apparatus by executing a control program stored in the storage unit 202. The storage unit 202 is a storage unit that stores control programs to be executed by the control unit 201, and various kinds of information for communication. Various operations to be described later can be implemented when the control unit 201 executes a control program stored in the storage unit 202. The wireless communication unit 203 is configured to perform wireless communication complying with a cellular communication standard such as the 3GPP® Long Term Evolution (LTE) standard or the 5th Generation (5G) standard. For example, the wireless communication unit 203 is configured to include a communication circuit such as a radio frequency (RF) circuit or a baseband (BB) circuit. The antenna control unit 204 controls an antenna for wireless communication performed by the wireless communication unit 203.

FIG. 3 is a block diagram showing an example of the functional configuration of the communication apparatus. For example, the communication apparatus is configured to include, as functions, a signal transmission unit 301, a signal reception unit 302, a data storage unit 303, a connection control unit 304, an RRC processing unit 305, a signal processing unit 306, and a connection determination unit 307.

The signal transmission unit 301 generates a signal complying with a cellular communication standard such as the 3GPP® LTE standard or the 5G standard, and transmits the signal to the IAB donor, the IAB node, or the like. The signal reception unit 302 receives a signal transmitted from the IAB donor, the IAB node, or the like, and executes processing such as demodulation and decoding. The signal transmission unit 301 and the signal reception unit 302 of the UE perform wireless communication with the IAB donor or the IAB node as the connection destination. On the other hand, the signal transmission unit 301 and the signal reception unit 302 of the IAB node perform wireless communication with the IAB donor or another IAB node connected for connection to the core network, and further performs wireless communication with the UE. The data storage unit 303 controls to store various kinds of information such as software, information concerning a communication partner, and communication parameters. The connection control unit 304 controls to establish wireless connection to another communication apparatus. The connection control unit 304 can control to establish connection to the core network via the wireless connection. For example, the connection control unit 304 of the UE establishes wireless connection by executing a random access procedure (RACH procedure) with the IAB donor or the IAB node. The connection control unit 304 of the IAB node sets a BAP address and routing under the control of the IAB donor after establishing wireless connection to the IAB donor or another IAB node, thereby setting a relay communication path to the IAB donor.

The RRC processing unit 305 performs radio resource control (RRC) layer setting processing with the partner apparatus as the connection destination. The signal processing unit 306 performs, for example, signal processing for the received signal. For example, the signal processing unit 306 obtains data that has been included in the notification signal transmitted from the IAB donor or the IAB node and has been demodulated and decoded by the signal reception unit 302, and performs analysis processing for the data. By the analysis processing, the signal processing unit 306 extracts, for example, information indicating whether a peripheral IAB node is a moving IAB node. The extracted information is stored under the control of the data storage unit 303. The signal processing unit 306 of the IAB node can perform signal processing of including, in the notification signal, the information indicating whether the self-apparatus is a moving IAB node. The information included as an information element of the notification signal by the signal processing unit 306 is transmitted, by the signal transmission unit 301, as a notification signal converted into a radio signal. The connection determination unit 307 determines whether to perform connection to an IAB node existing on the periphery. Based on, for example, information included in a notification signal received from a peripheral IAB node, the connection determination unit 307 determines whether the IAB node is a moving IAB node. Then, the connection determination unit 307 can determine not to perform connection to the moving IAB node. Note that as an example, in a case where it is determined that the self-apparatus moves together with the moving IAB node, the connection determination unit 307 may determine to perform connection to the moving IAB node. For example, the UE held by the user who uses the train in which the IAB node is installed moves together with the IAB node. In this case, the UE may determine to be connected to the IAB node. As an example, in a case where the radio quality of a radio signal from the moving IAB node falls within a sufficiently good predetermined range for a sufficiently long (for example, one minute or more) predetermined period, the UE can determine that it moves together with the moving IAB node.

### (Procedure of Processing)

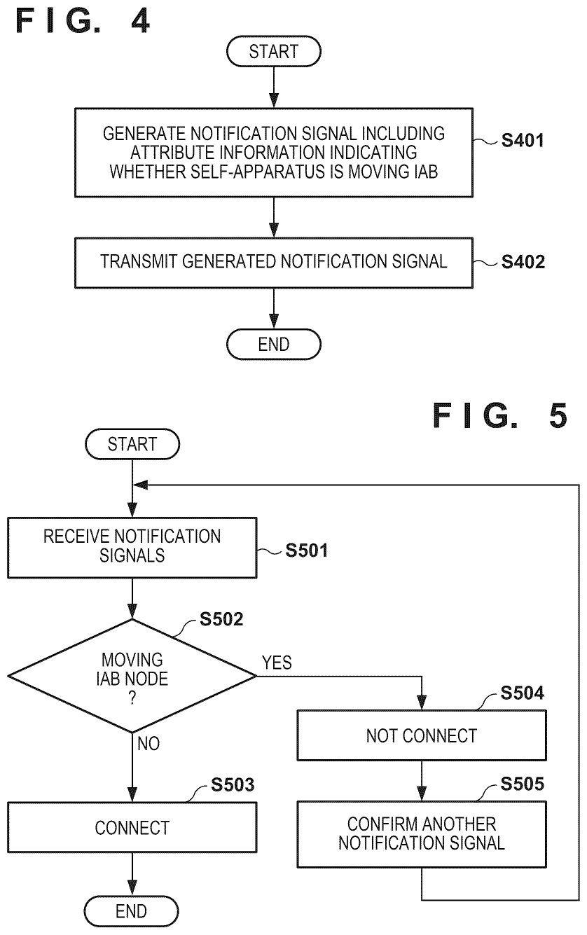

FIG. 4 shows an example of the procedure of processing executed by the IAB node. Note that this processing indicates the processing of the IAB node connected (directly or via another IAB node) to the IAB donor. Note also that in a case where it is necessary to newly decide a connection destination, the communication apparatus that can function as an IAB node can execute the processing (to be described later) of the UE. Note also that this processing can be implemented when, for example, the control unit 201 of the IAB node executes a program stored in the storage unit 202. Note also that dedicated hardware for executing this processing may be used.

The IAB node generates a notification signal to include attribute information indicating whether the self-apparatus is a moving IAB node (step S401). Note that the IAB node can hold, in advance, in the storage unit 202, setting information indicating whether the self-apparatus is an IAB node, and generate a notification signal based on the information. Then, the IAB node broadcasts the generated notification signal (step S402).

FIG. 5 shows an example of the procedure of the processing executed by the UE (or the communication apparatus that can function as an IAB node but is in an unconnected state). Note that this processing can be implemented when, for example, the control unit 201 of the communication apparatus such as the UE executes a program stored in the storage unit 202. Note also that dedicated hardware for executing this processing may be used.

In order to select a connection target base station, the UE receives notification signals (SSBs) from base stations existing on the periphery (step S501). Note that the notification signal is transmitted not only from the IAB node but also from the IAB donor, and is also transmitted from a base station that does not use the IAB technique. Upon receiving the notification signals, for example, the UE can select the base station with the highest (SSB) radio quality as a candidate of the connection destination base station. The radio quality can be, for example, a Received Signal Strength Indicator (RSSI), Reference Signal Received Power (RSRP), Reference Signal Received Quality (RSRQ), or the like. The UE confirms the attribute information included in the notification signal transmitted by the selected base station, and determines whether the base station is a moving IAB node (step S502). If the selected base station is not a moving IAB node (NO in step S502), the UE decides to be connected to the base station (step S503). On the other hand, if the selected base station is a moving IAB node (YES in step S502), the UE decides not to be connected to the base station (step S504), and confirms the notification signal from another base station (step S505). For example, the UE can exclude the notification signal from the moving IAB node from measurement targets, and restart the reception of the notification signal transmitted from the base station such as another IAB node (step S501). Then, the UE can be connected to, among the base stations such as another IAB node, the base station with satisfactory SSB radio quality, which is not a moving IAB node. Note that the UE may simultaneously receive notification signals from a plurality of base stations and select a connection destination base station based on the radio quality from the base stations that are not moving IAB nodes. That is, FIG. 5 shows an example of a case where notification signals from a plurality of base stations are sequentially received, but the reception processes may be performed simultaneously.

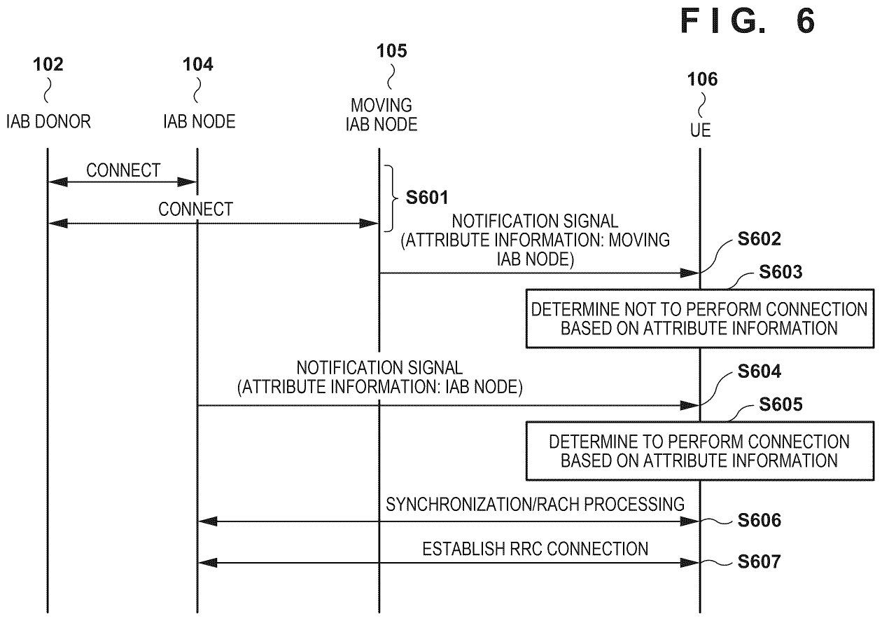

FIG. 6 shows an example of the procedure of communication in a case where the processes shown in FIGS. 4 and 5 are performed in the system shown in FIG. 1. In the system shown in FIG. 1, each of the IAB node 104 and the IAB node 105 establishes connection to the IAB donor 102 (S601). This connection is established when each of the IAB node 104 and the IAB node 105 serves as a terminal to execute processing of performing connection to the IAB donor 102 as a base station. After the establishment of the wireless connection, the IAB donor 102 assigns a BAP address to each of the IAB node 104 and the IAB node 105, and sets routing information. This allows each of the IAB node 104 and the IAB node 105 to relay wireless communication between the UE and the IAB donor 102. If each of the IAB node 104 and the IAB node 105 can relay communication of the IAB donor 102, it transmits a notification signal. In this example, since the IAB node 105 is a moving IAB node, it generates a notification signal including attribute information indicating a moving IAB node, and transmits the notification signal (S602). Upon receiving the notification signal, the UE 106 confirms the attribute information. Based on the attribute information of the notification signal transmitted from the IAB node 105, the UE 106 specifies that the IAB node 105 is a moving IAB node. Since the IAB node 105 is a moving IAB node, the UE 106 determines not to be connected to the IAB node 105 (S603).

On the other hand, since the IAB node 104 is a non-moving IAB node, it generates a notification signal including attribute information indicating not a moving IAB node, and transmits the notification signal (S604). Note that the IAB donor or the IAB node that is not a moving IAB node may transmit a notification signal including no attribute information. That is, the UE can determine, in a case where the attribute information is included, that the base station as the transmission source of the notification signal is a moving IAB node, and can determine, in a case where no attribute information is included, that the base station as the transmission source of the notification signal is not a moving IAB node. As described above, in a case where the UE need only specify whether the transmission source of the notification signal is a moving IAB node, it may be possible to specify, based on the presence/absence of the attribute information, whether the transmission source of the notification signal is a moving IAB node. Note that in a case where the UE should determine whether the transmission source of the notification signal is a moving IAB node, a non-moving IAB node, or a base station of another type, the IAB node 104 can transmit the notification signal including the attribute information indicating not a moving IAB node. In this embodiment, base on the attribute information of the notification signal transmitted from the IAB node 104, the UE 106 specifies that the IAB node 104 is not a moving IAB node. Then, since the IAB node 104 is not a moving IAB node, the UE 106 determines to be connected to the IAB node 104 (S605). The UE 106 executes synchronization establishment processing and RACH processing with the IAB node 104 (S606), and then performs connection setting of the RRC layer (S607), thereby establishing connection to the IAB node 104.

As described above, in this embodiment, each IAB node transmits a notification signal including attribute information indicating whether the self-apparatus is a moving IAB node. Upon receiving the notification signal, the UE determines, based on the attribute information, whether the IAB node as the transmission source of the notification signal is a moving IAB node. Then, the UE controls not to be connected to the moving IAB node. Thus, the UE is connected to the fixed IAB node, thereby making it possible to prevent unnecessary handover from occurring.

Note that as described above, when it is assumed that the UE moves together with a moving IAB node, the UE may be connected to the moving IAB node. That is, in an environment where the relative positional relationship between the moving IAB node and the UE remains largely unchanged, the UE may be connected to the moving IAB node. For example, as described above, the UE may continuously measure the radio quality of the SSB from the moving IAB node, and if the change amount of the radio quality remains equal to or smaller than a predetermined level for a predetermined time, the UE may be connected to the moving IAB node. For example, if the UE enters a predetermined space such as a train, the UE may be controlled to permit connection to the moving IAB node associated with the predetermined space. For example, the moving IAB node notifies the UE of information indicating a space as additional information of the attribute information, and if the position of the UE is included in the space, the UE may allow connection to the moving IAB node. In this case, the UE can allow connection to, among the moving IAB nodes, only the moving IAB node that moves together with the UE, and allow no connection to the remaining moving IAB nodes. Thus, when the UE is connected to the moving IAB node that moves together with the self-apparatus, it is possible to prevent handover from occurring during the movement.

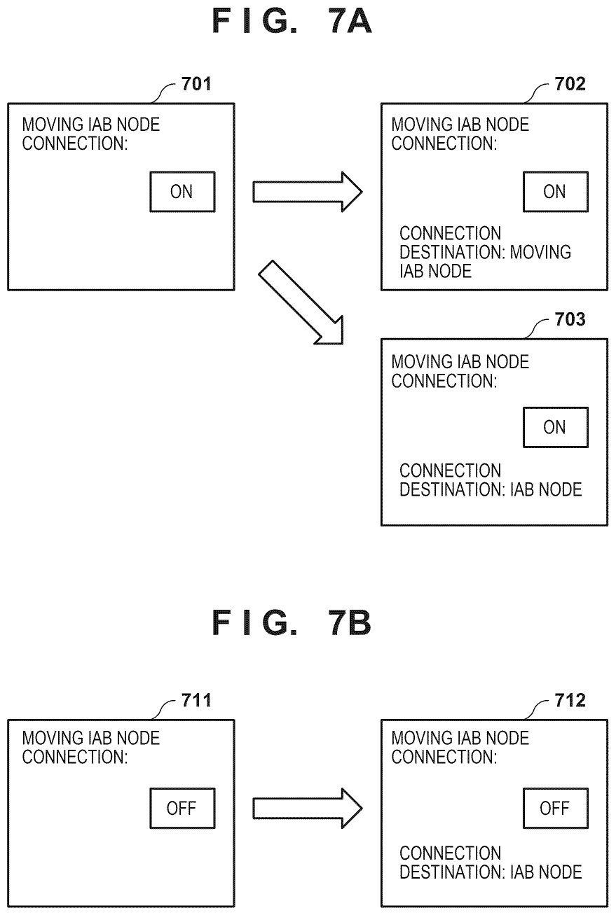

Note that the UE may accept a user operation of whether to permit connection to a moving IAB node. For example, on a screen such as a screen 701 shown in FIG. 7A or a screen 711 shown in FIG. 7B, a user operation of whether to permit connection to a moving IAB node is accepted. Then, if an operation of permitting connection to a moving IAB node is accepted as indicated by the screen 701 shown in FIG. 7A, the UE is connected to, for example, a base station with the most satisfactory SSB radio quality, regardless of whether the transmission source of the notification signal is a moving IAB node. For example, if the radio quality of the SSB transmitted from the IAB node 105 as a moving IAB node is most satisfactory, the UE 106 selects the IAB node 105 as a connection destination. As indicated by a screen 702, the UE 106 can indicate that the moving IAB node is selected as a connection destination. For example, if the radio quality of the SSB transmitted from the IAB node 104 as a non-moving IAB node is most satisfactory, the UE 106 selects the IAB node 104 as a connection destination. As indicated by a screen 703, the UE 106 can indicate that the non-moving IAB node is selected as a connection destination. On the other hand, if an operation of not permitting connection to a moving IAB node is accepted as indicated by the screen 711 shown in FIG. 7B, the UE excludes a moving IAB node from connection destination candidates, and selects a connection destination. For example, even if the radio quality of the SSB transmitted from the IAB node 105 as a moving IAB node is most satisfactory, the UE 106 excludes the IAB node 105 from connection destination candidates. Then, the UE 106 selects the non-moving IAB node 104 as a connection destination, and displays a screen 712. With such screen display and acceptance of an operation, in a case where, for example, the user uses a train, he/she can permit connection to a moving IAB node, and connect the UE to the moving IAB node that moves together with the UE. For example, the user of the UE 107 shown in FIG. 1 can connect the UE 107 to the IAB node 105 by making a setting of permitting connection to the moving IAB node.

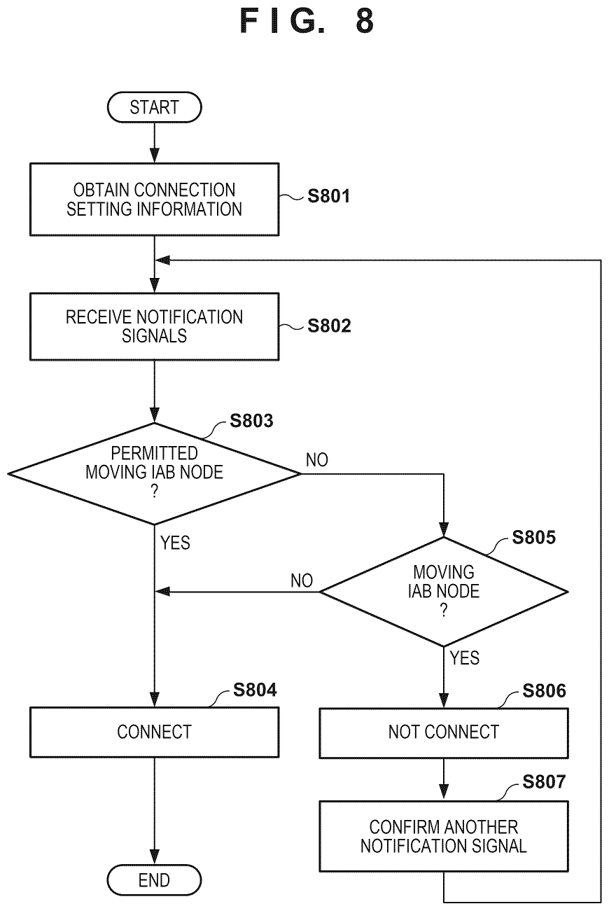

FIG. 8 shows an example of the procedure of processing executed by the UE when accepting a user operation. In this processing, first, the UE accepts a connection setting by the user via the screen shown in FIG. 7A or 7B. Note that if the connection setting has been accepted in the past, the UE may store information of the connection setting. In this case, the UE can obtain connection setting information by reading out the stored information of the connection setting (step S801). To select a connection target base station, the UE receives notification signals (SSBs) from base stations existing on the periphery (step S802). At this time, the UE determines, based on the connection setting information, whether connection to a moving IAB node is permitted (step S803). If connection to a moving IAB node is permitted (YES in step S803), for example, the UE sets, as a connection destination base station, a base station with the highest SSB radio quality, and establishes connection to the base station (step S804). That is, in this case, since the UE permits connection to a moving IAB node, it can decide a connection destination in accordance with radio quality without confirming attribute information included in the notification signal.

On the other hand, if connection to a moving IAB node is not permitted (NO in step S803), the UE performs the same processes as those in step S502 to S505 of FIG. 5. That is, for example, the UE can select, as a candidate of a connection destination base station, a base station with the highest SSB radio quality. Then, the UE confirms the attribute information included in the notification signal transmitted by the selected base station, and determines whether the base station is a moving IAB node (step S805). If the selected base station is not a moving IAB node (NO in step S805), the UE decides to be connected to the base station (step S804). On the other hand, if the selected base station is a moving IAB node (YES in step S805), the UE decides not to be connected to the base station (step S806), and confirms the notification signal from another base station (step S807). For example, the UE can exclude the notification signal from the moving IAB node from measurement targets, and restart the reception of the notification signal transmitted from the base station such as another IAB node (step S802). Then, the UE can be connected to, among the base stations such as another IAB node, the base station with satisfactory SSB radio quality, which is not a moving IAB node. Note that the UE may simultaneously receive notification signals from a plurality of base stations and select a connection destination base station based on radio quality from the base stations that are not moving IAB nodes. That is, FIG. 8 shows an example of a case where notification signals from a plurality of base stations are sequentially received, but the reception processes may be performed simultaneously.

With this processing, when the user makes an appropriate setting in accordance with a status, it is possible to connect the UE to a connection destination in which handover is difficult to occur. Note that in a case where connection to a moving IAB node is permitted, the UE may control to be connected to only a moving IAB node.

It is assumed that a moving IAB node according to this embodiment includes, in a notification signal for UE, attribute information indicating a moving IAB node, but the present disclosure is not limited to this. A notification signal for node detection or measurement, which is transmitted between IAB nodes at a timing different from that of the notification signal for UE, may include attribute information indicating a moving IAB node. The notification signal for node detection or measurement, which is transmitted between IAB nodes, is also called a second notification signal. In this case, a moving IAB node appropriately sets the transmission cycle and timing of the second notification signal for an IAB node. Note that the notification signal for UE and the second notification signal are pieces of notification information transmitted for different purposes, and can include different pieces of attribute information.

While periodically transmitting the notification signal for UE at a first timing, the moving IAB node periodically transmits the second notification signal at a second timing different from the first timing. With this processing, it is possible to transmit the second notification signal including the attribute information indicating a moving IAB node not only to the UE but also to the peripheral IAB node and IAB donor.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
a reception unit configured to receive a notification signal from an Integrated Access and Backhaul (IAB) node;
a determination unit configured to perform determination of whether attribute information indicating that an IAB node as a transmission source of the notification signal is a moving IAB node configured to be movable is included in the notification signal; and
a decision unit configured to decide, based on the determination, whether to perform connection to the IAB node as the transmission source of the notification signal.

2. The communication apparatus according to claim 1, wherein
the determination unit determines, in a case where the attribute information is included in the notification signal, that the IAB node as the transmission source of the notification signal is the moving IAB node, and determines, in a case where the attribute information is not included in the notification signal, that the IAB node as the transmission source of the notification signal is not the moving IAB node.

3. The communication apparatus according to claim 1, wherein
the determination unit determines, in a case where attribute information indicating that the IAB node as the transmission source of the notification signal is the moving IAB node is included in the notification signal, that the IAB node as the transmission source of the notification signal is the moving IAB node, and determines, in a case where attribute information indicating that the IAB node as the transmission source of the notification signal is not the moving IAB node is included in the notification signal, that the IAB node as the transmission source of the notification signal is a non-moving IAB node.

4. The communication apparatus according to claim 1, wherein
in a case where attribute information indicating that the IAB node as the transmission source of the notification signal is the moving IAB node is included in the notification signal, the decision unit decides not to perform connection to the IAB node as the transmission source of the notification signal.

5. The communication apparatus according to claim 1, further comprising a unit configured to accept a user operation of whether to permit connection to a moving IAB node,
wherein in a case where the user operation of not permitting connection to the moving IAB node is accepted and attribute information indicating that the IAB node as the transmission source of the notification signal is the moving IAB node is included in the notification signal, the decision unit decides not to perform connection to the IAB node as the transmission source of the notification signal.

6. The communication apparatus according to claim 5, wherein
in a case where the user operation of permitting connection to the moving IAB node is accepted, the decision unit decides a connection destination regardless of the attribute information.

7. The communication apparatus according to claim 5, wherein
in a case where the user operation of permitting connection to the moving IAB node is accepted, the decision unit decides to perform connection to the moving IAB node.

8. The communication apparatus according to claim 1, further comprising an estimation unit configured to estimate, in a case where attribute information indicating that the IAB node as the transmission source of the notification signal is the moving IAB node is included in the notification signal, whether the moving IAB node moves together with the communication apparatus,
wherein in a case where it is estimated that the moving IAB node moves together with the communication apparatus, the decision unit decides to perform connection to the moving IAB node.

9. The communication apparatus according to claim 8, wherein
in a case where a change amount of radio quality of a radio signal transmitted from the moving IAB node is not more than a predetermined level for a predetermined period, the estimation unit determines that the moving IAB node moves together with the communication apparatus.

10. The communication apparatus according to claim 8, wherein
in a case where the communication apparatus is located in a space associated with the moving IAB node, the estimation unit determines that the moving IAB node moves together with the communication apparatus.

11. The communication apparatus according to claim 1, wherein
the communication apparatus is user equipment (UE).

12. The communication apparatus according to claim 1, wherein
the communication apparatus is a communication apparatus that can function as an IAB node different from the IAB node as the transmission source of the notification signal.

13. A communication apparatus functioning as an Integrated Access and Backhaul (IAB) node, comprising:
a generation unit configured to generate, in a case where the communication apparatus is a moving IAB node configured to be movable, a first notification signal for User Equipment (UE), which includes attribute information indicating that the communication apparatus is the moving IAB node, and a second notification signal for an IAB node, which is different from the first notification signal and includes attribute information indicating that the communication apparatus is the moving IAB node; and
a transmission unit configured to transmit the first notification signal and the second notification signal at different timings.

14. The communication apparatus according to claim 13, wherein
in a case where the communication apparatus is not the moving IAB node, the generation unit generates the first notification signal and the second notification signal, each of which does not include the attribute information.

15. The communication apparatus according to claim 13, wherein
in a case where the communication apparatus is not the moving IAB node, the generation unit generates the first notification signal and the second notification signal, each of which includes attribute information indicating that the communication apparatus is not the moving IAB node.

16. A control method executed by a communication apparatus, comprising:
receiving a notification signal from an Integrated Access and Backhaul (IAB) node;
performing determination of whether attribute information indicating that an IAB node as a transmission source of the notification signal is a moving IAB node configured to be movable is included in the notification signal; and
deciding, based on the determination, whether to perform connection to the IAB node as the transmission source of the notification signal.

17. A control method executed by a communication apparatus functioning as an Integrated Access and Backhaul (IAB) node, comprising:
generating, in a case where the communication apparatus is a moving IAB node configured to be movable, a first notification signal for User Equipment (UE), which includes attribute information indicating that the communication apparatus is the moving IAB node, and a second notification signal for an IAB node, which is different from the first notification signal and includes attribute information indicating that the communication apparatus is the moving IAB node; and
transmitting the first notification signal and the second notification signal at different timings.

18. A non-transitory computer-readable storage medium that stores a program for causing a computer included in a communication apparatus to perform a control method comprising:
receiving a notification signal from an Integrated Access and Backhaul (IAB) node;
performing determination of whether attribute information indicating that an IAB node as a transmission source of the notification signal is a moving IAB node configured to be movable is included in the notification signal; and
deciding, based on the determination, whether to perform connection to the IAB node as the transmission source of the notification signal.

19. A non-transitory computer-readable storage medium that stores a program for causing a computer included in a communication apparatus, which operates as an Integrated Access and Backhaul (IAB) node, to perform a control method comprising:
generating, in a case where the communication apparatus is a moving IAB node configured to be movable, a first notification signal for User Equipment (UE), which includes attribute information indicating that the communication apparatus is the moving IAB node, and a second notification signal for an IAB node, which is different from the first notification signal and includes attribute information indicating that the communication apparatus is the moving IAB node; and
transmitting the first notification signal and the second notification signal at different timings.
